(19) United States
(12) Patent Application Publication
(10) Pub. No.: US 2005/0238206 A1
(43) Pub. Date: Oct. 27, 2005

(54) Method and device for identifying individuals

(75) Inventors: Gunter Doemens, Holzkirchen (DE); Frank Forster, Munchen (DE)

Correspondence Address: YOUNG & THOMPSON, 745 SOUTH 23RD STREET, 2ND FLOOR, ARLINGTON, VA, 22202, US

(73) Assignee: Siemens Aktiengesellschaft, Munchen (DE)

(21) Appl. No.: 10/518,514

(22) PCT Filed: Jun. 10, 2003
(86) PCT No.: PCT/DE03/01911

§ 371 Date: Dec. 20, 2004

(30) Foreign Application Priority Data
Jun. 18, 2002 (DE) 102 27 167.4

(51) Int. Cl. G06K 9/00

(52) U.S. Cl. 382/115

(57) ABSTRACT

The aim of the invention is to improve the biometric identification of individuals (1) involving the use of a single optical sensor. To this end, both a part of the face (4) as well as a part of the hand (5) of the individual (1) to be identified are recorded in three dimensions and evaluated.

The invention relates to a method for identifying individuals, whereby a part of the face of the individual to be identified is recorded by means of an optical sensor and evaluated in an evaluating unit.

The invention relates further to a device for identifying individuals using an optical sensor which works together with an evaluating unit.

The automatic identification or verification of individuals by means of biometric methods will become increasingly important in the future. The purpose of developing the biometric method is to ensure an increased identification and deception security with a simultaneously high user acceptance as well as low costs. One field of application of the biometric method is primarily the monitoring of the access authorization into buildings and rooms, as well as the monitoring of the access authorization into electronic systems.

At present, the following biometric methods are essentially used; two-dimensional face identification, evaluation of finger prints, iris identification, hand identification as well as voice recognition. None of the biometric methods have hitherto become widely accepted. This is mainly due to restricted identification security, to partially inadequate user acceptance or to excessively high system costs. The identification of finger prints is particularly difficult, since users are occasionally reluctant to place their hand or finger onto a sensor surface due to reasons of hygiene. In many cases, the detection of the iris of an individual to be identified is also unwanted at times on the grounds that it allows specific personal information to be recorded. Iris identification is therefore sometimes rejected for data protection reasons.

Two-dimensional or three-dimensional face identification has significant advantages in terms of user acceptance. Two-dimensional or three-dimensional face identification is a non-contact method which is harmless in terms of data protection. Nevertheless two-dimensional face identification fails to achieve the required reliability, the typical identification rate being approximately 95%, with the individual to be identified being wrongly rejected in 5% of cases. By contrast, approximately 0.5% of unauthorised individuals are mistakenly identified and authorised. Biometric methods are currently in the process of being developed whereby face identification is carried out in three dimensions. The use of three-dimensional face identification significantly improves the identification rate. However further improvements to the method and increased identification values are still required, and this should be able to be achieved as far as possible without any significant additional costs.

Based on this prior art, the object of the invention is to create a non-contact biometric method which offers high reliability values without significantly large system costs. A further object of the invention is to create a device for implementing the method.

These objects are achieved by means of a method and a device according to the features of the independent Claims. Advantageous embodiments and developments of the invention are specified in the dependent Claims.

In addition to a part of the face, said method enables a part of the hand of the individual to be identified also to be recorded by an optical sensor, and evaluated by the evaluating unit. This is advantageous in that at least two significantly structured characteristic parts of the body of the individual to be identified are consulted in order to carry out the identification. Since the identification is not only based on recording a part of the face, it can be expected that with the implementation of said method the reliability values are above the reliability values of a conventional method exclusively based on identifying parts of the face or the hand. Consequently it is also far more difficult than with prior art to deceive a device which implements said method, since it is assumed that both a part of the face and a part of the hand of the individual to be identified are reproduced, which is considerably more difficult to achieve than if only one part of the body must be reproduced.

One device for implementing the method is designed advantageously such that the optical sensor and the evaluating unit are able to record and identify a part of the face and a part of the hand of an individual to be identified.

The recording and identification of a part of the face and a part of the hand does not necessarily have to take place at the same time. Nevertheless the identification of a part of the face and a part of a hand can be carried out at the same time, the time needed to record a part of the face and a part of the hand thereby being reduced.

The simultaneous recording of a part of the face and a part of the hand is advantageously implemented such that an upper part of the face of the individual to be identified is recorded and the recording and identification of a part of the hand is carried out in an area of a lower part of the face. This is advantageous in that the area of the face below the upper jaw varies considerably depending on the position of the mouth and the beard growth and is therefore also restricted in its suitability to identifying and verifying individuals.

In principle, it is also possible to implement the method according to the invention in two dimensions. The length of the fingers recorded in two dimensions is heavily dependent on the curvature of the finger. It is therefore to be expected that significantly improved reliability values can be achieved by using the three-dimensional implementation of the method.

The invention is described below in detail with reference to the attached drawing, in which;

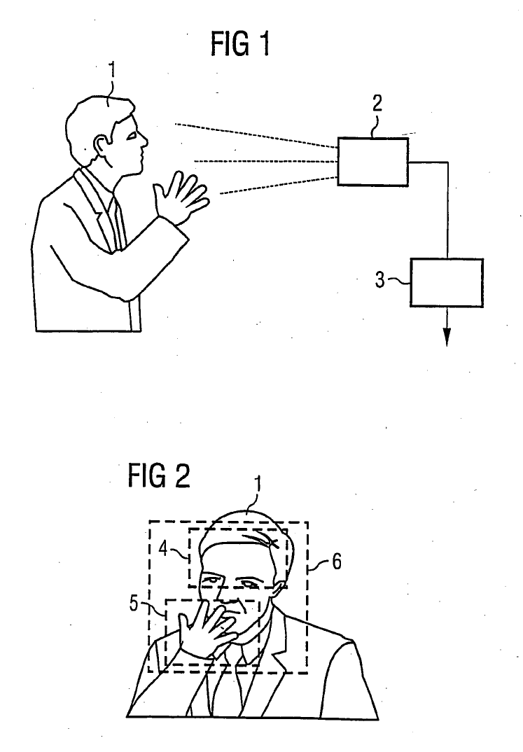

FIG. 1 shows a schematic representation of a device for implementing the method, and

FIG. 2 shows a representation of a part of the face and a part of the hand evaluated by implementing the method.

FIG. 1 displays the individual 1 to be identified, with his or her two-dimensional or three-dimensional image being recorded by means. of an optical sensor 2. The optical sensor 2 is connected to an evaluating unit 3.

The optical sensor 2 detects a part of the face 4 illustrated in FIG. 2, which preferably starts at the upper jaw and extends out to the forehead area. The optical sensor 2 also records a part of the hand 5 which preferably extends below a part of the face 4, if the individual to be identified holds their hand close to their face.

The optical sensor 2 can be configured such that it is able to provide both a two-dimensional and three-dimensional image of a part of the face 4 and a part of the hand 5. Both a part of the hand 5 and a part of the face 4 are located within an entire face field 6 of the optical sensor 2. A single optical sensor is sufficient to implement the method. The method can be implemented without any considerable cost. With a modified method which costs more, two or three optical sensors can be used to record for instance, parts of the body of a user from different perspectives.

The conventional imaging method is used to generate a two-dimensional image of a part of the face 4 and a part of the hand 5. The so-called triangulation is particularly suited to generating a three-dimensional image of a part of the face 4 and a part of the hand 5. This particularly involves scanning a part of the face 4 and a part of the hand 5 with the aid of a laser scanner or with the aid of the light-slit method. Both methods are known to a person skilled in the art and are thus not set down in the subject of the application. The light-slit method is particularly advantageous, since in this case a three-dimensional image of a part of the face 4 and a part of the hand 5 can be generated within 40 ms. In this respect, it must be ensured that the three-dimensional image of a part of the face 4 and a part of the hand 5 are not falsified by a possible movement of the individual to be identified.

On the other hand, the quick three-dimensional recording of a face and a hand facilitates the determination of whether the detected object is a falsification with fixed masks, since a movement of the face and or the hand can be recorded by means of successive recording processes. In addition, the identification accuracy can be improved if a movement characteristic to the user is recorded and evaluated. A movement of this type can for example be the movement of a finger on a hand. A movement of this type can only be reproduced with a huge effort in the case of a mask.

The two-dimensional image of a part of the face 4 and a part of the hand 5 is not implicitly necessary. The two-dimensional identification of a part of the face 4 and a part of the hand 5 can nevertheless be used to determine the spatial area to be recorded for the two-dimensional identification, by means of the two-dimensional recording of a part of the face 4 and a part of the hand 5, since as a rule the individual 1 to be identified guides the hand to a different position on the face. The two dimensional image of an individual 1 can thus be used to determine the position of the part of the hand 5 in relation to a part of the face 4.

It is expected that with the use of the method described here higher reliability can be achieved than with the known method, on the basis of the evaluation of two strongly structured body parts. It is particularly advantageous that a single, optical sensor 2 is sufficient to implement the method. In the method described here, two identification processes independent of one another can be implemented without any additional costs, the overall result of which significantly exceeding the reliability values achievable using the prior art to date.

It is of further advantage that the method described here can be implemented quickly and in a non-contact manner. It is thus to be expected that the method described here is generally accepted by all users.

Incidentally the method set out here provides an increased protection against deception, since said method is based on the evaluation of three-dimensional images, which are essentially more difficult to reproduce than two-dimensional images. On the other hand, two body parts independent of one another are evaluated with the device and method described here. Since it is far more difficult to reproduce two body parts than just one single body part, the method disclosed here comprises an increased protection against falsifications.

It should be noted that both hands of the individual to be identified can be recorded and evaluated with a modified method. It is further possible to use a method and a device with additional individual identification systems, like for example voice recognition or finger prints. A graded control of individuals is conceivable in order to ensure adequate frequency. By way of example, the sensor operating in a non-contact manner according to this invention would be sent in for a series control, and voice recognition or finger prints can be used in critical cases.

1-15. (canceled)

16. Method for recording individuals (1), whereby at least one subarea of the face (4) and at least one subarea of a hand (5) of the individual (1) to be identified is recorded with the aid of a single optical sensor (2) using optical triangulation to determine three-dimensional spacial coordinates and are evaluated in an evaluating unit (3).

17. Method according to claim 16 whereby the at least one subarea of the face (4) and the at least one subarea of the hand (5) is recorded in an imaging process.

18. Method according to claim 17 whereby a part of the face (4) or a part of the hand (5) is recorded in three dimensions with the aid of triangulation.

19. Method according to claim 18 whereby a part of the face (4) or a part of the hand (5) is recorded in three dimensions with the aid of a light-slit method.

20. Method according to claim 18 whereby the at least one subarea of the face (4) or the at least one subarea of the hand (5) is recorded in three dimensions with the aid of a laser scanner.

21. Method according to claim 16, whereby the at least one subarea of the face (4) or the at least one subarea of the hand (5) is recorded by the optical sensor (2) additionally in two dimensions.

22. Method according to claim 16 whereby the at least one subarea of the face (4) or the at least one subarea of the hand (5) are recorded repeatedly by the optical sensor (2) in order to record a movement.

23. Device for identifying a person (1) by means of an optical sensor (2), which works together with an evaluating unit (3), characterised in that the optical sensor (2) and the evaluating unit (3) are able to record and identify the face (4) and the hand (5) of the individual to be identified (1).

24. Device according to claim 23 whereby the optical sensor (2) records both the at least one subarea of the face (4) or the at least one subarea of the hand (5) in an imaging process.

25. Device according to claim 23 whereby the optical sensor (2) records the face (4) or the hand (5) partially or completely in three dimensions.

26. Device according to claim 25 whereby the optical sensor (2) is configured to implement a triangulation.

27. Device according to claim 23 whereby the optical sensor (2) is configured to implement an imaging method.

28. Device according to claim 23 whereby the optical sensor (2) is configured to partially or completely record a movement by repeatedly recording the face (4) or the hand (5).

29. Method according to claim 17, whereby the at least one subarea of the face (4) or the at least one subarea of the hand (5) is recorded by the optical sensor (2) additionally in two dimensions.

30. Method according to claim 18, whereby the at least one subarea of the face (4) or the at least one subarea of the hand (5) is recorded by the optical sensor (2) additionally in two dimensions.

31. Method according to claim 19, whereby the at least one subarea of the face (4) or the at least one subarea of the hand (5) is recorded by the optical sensor (2) additionally in two dimensions.

32. Method according to claim 20, whereby the at least one subarea of the face (4) or the at least one subarea of the hand (5) is recorded by the optical sensor (2) additionally in two dimensions.

33. Method according to claim 17 whereby the at least one subarea of the face (4) or the at least one subarea of the hand (5) are recorded repeatedly by the optical sensor (2) in order to record a movement.

34. Method according to claim 18 whereby the at least one subarea of the face (4) or the at least one subarea of the hand (5) are recorded repeatedly by the optical sensor (2) in order to record a movement.

35. Method according to claim 19 whereby the at least one subarea of the face (4) or the at least one subarea of the hand (5) are recorded repeatedly by the optical sensor (2) in order to record a movement.
